(19) United States
(12) Patent Application Publication
(10) Pub. No.: US 2003/0053605 A1
(43) Pub. Date: Mar. 20, 2003

(54) System and method for facilitating paperless transactions related to acquisition and management of telephony type communications services such as local and long distance communications services

(76) Inventor: James P. Cashiola, Austin, TX (US)

Correspondence Address: Erik B. Cherdak & Associates, LLC, Suite 906, 11300 Rockville Pike, Rockville, MD, 20852, US

(21) Appl. No.: 09/951,886

(22) Filed: Sep. 14, 2001

(51) Int. Cl. H04M 1/64

(52) U.S. Cl. 379/88.17

(57) ABSTRACT

System and method for facilitating paperless transactions related to local and long distance type telecommunications services provided within a telecommunications network. Such new and improved systems and methods include and involve a telecommunications network wherein at least one local or long distance type communications service is provided to a customer, and a paperless services system that is coupled to the telecommunications network via an electronic data network such as the Internet and World Wide Web (www). The telecommunications network and the electronic data network may be one in the same. The paperless services system is configured to be accessed by the customer via the electronic data network to enable the customer to engage in at least one paperless transaction related to the communications service(s) provided to the customer within the telecommunications network. Consumers of telecommunications services will benefit from the present invention by obtaining greater control over their communications needs and, in particular, will gain the ability to self direct and self-provision the services they need as well as manage those services in real time.

### BACKGROUND OF THE INVENTION

1. Field of the Invention

The present invention relates to systems and methods used to facilitate paperless transactions related to acquisition and management of communications services such as those concerned with telephony type communications services such as local and long distance communications services.

2. Description of the Related Art

Despite incredible advances in communications technologies over the past several years, obtaining telecommunications services such as voice services for local and long distance communications, data services, broadband services, and wireless services still requires the application of business practices which are riddled with inefficiencies, high costs, and, at worst, paper based processes that do not permit consumers to self direct and manage their communications solutions to meet their particular, individualized needs.

Take for example, purchasing and obtaining residential telephone service. Typically, a consumer has to call a central telephone service facility or office, request service, receive a confirmation or order number, and then wait until a scheduled date for a live operator to simply and merely “flip a switch” and update a database record to control telecommunications devices (e.g., switches and switch tables, etc.) to activate service for the consumer. Then, after service is initiated, the consumer must wait for periodic (usually monthly) paper statements that are sent via post such as the U.S. Mail to learn about telephone service usage, call rates, and call details. The consumer is completely and entirely at the mercy of his telephone service company in terms of accessing account details (e.g., to obtain account usage information and account balances, to change contact telephone information, etc.), learning about telephone service usage, and controlling and managing account changes such as those associated with enhanced calling services (e.g., call waiting, caller ID, voicemail, call forwarding, etc.).

Another example of modern inefficiency is seen with regard to cellular or wireless communications. Typically, a consumer has to visit a wireless communications store, purchase a telephone set, pick from a menu of features and pricing plans, submit an order for service, and then wait for activation prior to placing his first wireless telephone call. And, then, like the residential telephone service customer, the wireless consumer must wait for periodically supplied paper based billing statements to learn about account usage and the like. Wireless consumers (also referred to as subscribers) do not currently have available systems and processes that facilitate self directing or managing their wireless accounts and account usage. It is not uncommon for a wireless subscriber to be surprised by account details that show up sometimes a month later.

Yet another example of modern inefficiencies is seen in the commercial world where business consumers of telecommunications services lack any form of system or process that will enable self direction and management of services, control of costs, and the ability to seek competitive pricing and services on an ad-hoc basis. Currently, business consumers, like the residential and wireless subscribers mentioned above, often must engage directly or indirectly in inefficient live operator based sessions to obtain services, meet with service provider account representative during live, in-person meetings to learn about account details, and to order and facilitate provisioning and use of new services.

Service providers have long recognized the foregoing problems associated with provisioning and management of telecommunications services, but have done little to address the same to bring greater efficiencies to market. Such problems are compounded when customers desire or otherwise seek new services such as digital subscriber line (DSL) and other related services. Unfortunately, service providers have focused their efforts on bringing new and enhanced telecommunications services to market, only to exacerbate the problems realized by consumers in terms of self management of efficiently provided services. For example, MCI (prior to merging with WORLDCOM) attempted to address problems associated with consumers having to sort through numerous paper billing statements to derive an accurate picture associated with telecommunications account usage across a variety of accounts for possibly a variety of services including voice services, paging services, and wireless services. In the MCI solution known as MCI-ONE (a trademark of MCI WORLDCOM, INC.), consumers receive a periodic (monthly) paper based, consolidated billing statement that lists by account, account usage details, etc. like any ordinary billing statement. Unfortunately, the MCI-ONE consolidated statement works only if all services are provided by one vendor such as MCI WORLDCOM, INC. and if the consumer is accepting of a periodic (monthly) paper based bill. MCI-ONE does not offer the consumer the ability to use modern technologies and practices to receive account details across services provided by more than one vendor, and the MCI-ONE statement has nothing to do with account detail setup such as service initiation which remains the province of live operator sessions, etc.

Other providers like or similar to CELLULAR ONE, INC., for example, have begun to use the Internet and World Wide Web (www) to allow customers to access a web site (e.g., www.getcellone.com) to engage in a on-line purchase transaction of a wireless telephone and periodic wireless services to be associated with the use of the selected, purchased wireless telephone phone device. Unfortunately, such transactions are merely front-end transactions that still require application of traditional back-end processes and resources (e.g., personnel) to actually process the user's on-line selections, set up accounts, establish service plans, etc. The on-line transactions are merely used to facilitate sales and are not replacements for otherwise paper based transactions that are initiated via the www instead of at wireless services outlets or stores.

Thus, there exists a need to provide new and improved systems and methods which permit telecommunications consumers to obtain and manage their telecommunications services based on their needs and without incorporating outdated business practices and inefficiencies. To be viable, such new and improved systems and methods must take advantage of modern technologies such as networking technologies and processes to permit consumers to self direct and manage their telecommunications services. And, such new and improved systems and methods must facilitate provisioning and management of telecommunications services in converging telecommunications networks via the Internet and World Wide Web (WWW) (and other similar or like networks).

The present invention squarely addresses the aforementioned problems and delivers such new and improved systems and methods which are described in detail below.

### SUMMARY OF THE INVENTION

The present invention solves the aforementioned problems and provides new and improved systems and methods for facilitating paperless transactions related to local and long distance telecommunications services provided within a telecommunications network. Such new and improved systems and methods include and Such new and improved systems and methods include and involve a telecommunications network wherein at least one DSL type communications service is provided to a customer, and a paperless services system that is coupled to the telecommunications network via an electronic data network such as the Internet and World Wide Web (www). The telecommunications network and the electronic data network may be one in the same. The paperless services system is configured to be accessed by the customer via the electronic data network to enable the customer to engage in at least one paperless transaction related to the communications service(s) provided to the customer within the telecommunications network. Consumers of telecommunications services will benefit from the present invention by obtaining greater control over their communications needs and, in particular, will gain the ability to self direct and self-provision the services they need as well as manage those services in real time.

The present invention is based on several fundamental notions. In particular, all communication services eventually will be electronic based services (e-services). That is, all services will be bought, sold, managed and transacted over the Internet and other similar global networks through a variety of protocols, transmission mediums, PDA's, wireless devices, backbone devices and vendors. Any company wishing to compete in this new world of communications must be prepared to operate over the Internet. Simply reducing the price on a paper invoice and mailing it won't satisfy customers embracing the Internet and demanding a world run in real-time.

Service providers will gain market share by offering personalized services. Self-provisioning and self-management gives customers the ability to customize their services. Providers now distinguish themselves from competition by delivering a better user experience. Now, as a result of the present invention, value is defined more in terms of customer control, convenience and ease-of-use, rather than strictly on price.

The closed, single-vendor proprietary networks are not suite for future communications service delivery. Multi-vendor, multi-protocol open networks will dominate the new world of communications. To accomplish this, software systems will be the core of network intelligence. Networks will need to support SS7, IN, IP, ATM, H.323, MGCP, Parlay, SIP and a host of protocols that have yet to be invented. Functionality must include multimedia call agents, protocol conversion, gatekeepers, applications, billing, costing, customer management, provisioning, e-commerce, fraud control, authentication, security and network management.

For next-generation systems to be viable the browser can be the only interface. The concept of location is where the Internet connection resides. Customers will demand that their Internet connection follows them rather than installed statically on a particular desktop PC. All systems must control, manage and deliver applications and content over the existing publicly switched telephone network “PSTN” infrastructure as well as all new world multimedia devices, protocols and languages as they are developed. Of course, everything must be integrated and seamless to the provider and the customer.

Every company that has tried it knows what a difficult task a multi-vendor integration effort is. Huge integration projects will cripple the companies attempting such a strategy in a market that moves in Internet-time. Opportunity cost alone is a reason to look for a more efficient model. The Internet model provides two key operational benefits—all network elements are managed from a single browser and back office, and customer care functions can be managed by the end-user at their direction and on their own schedule.

By unifying the gamut of technologies available along with Internet-based front and back office applications and transaction-based billing, the present invention makes a new range of services and selling opportunities possible.

Existing proprietary technology and new technologies can for the first time, easily coexist which preserves existing investments, fully utilizes powerful existing technologies and leaves the door open for future technologies that become available.

The present invention supports carrier class TDM technologies by Nortel, Lucent, Ericsson, Siemens, Nokia, Alcatel and Cisco and a host of others. Through MGCP and H.323, the present invention supports all IP-based products. In the context of the present invention, SS7 is fully supported.

Scalability and standards compliance are only two of the hurdles to success in what is now a new, converging telecommunications market. Transactional billing and taxation are the next economic impacts of the Internet which most vendors are unprepared to handle. As such, ISPs and backbone providers will soon want to be reimbursed on a usage basis for their services. As with anything successful as an economic force, taxation is soon to follow as worldwide issues surrounding revenue generation on the Internet continue to build momentum. Transactional billing as now provided and supported by the present invention opens the door to a host of new products and services offered on-demand and in real-time.

As such, in solving the aforementioned problems associated with prior systems and processes, and in achieving the above-stated benefits, the present invention provides new and improved systems and methods for facilitating paperless transactions related to telecommunications services provided within a telecommunications network. Such systems and methods include and involve a telecommunications network wherein at least one communications service is provided to a customer, and a paperless services system that is coupled to the said telecommunications network via an electronic data network such as the Internet and World Wide Web (www). The paperless services system is configured to be accessed by the customer via the electronic data network to enable the customer to engage in at least one paperless transaction related to the communications service(s) provided to the customer within said telecommunications network.

### BRIEF DESCRIPTION OF THE DRAWING FIGURES

The present invention is described in detail below with reference to the attached drawing figures, of which:

FIG. 1 is a diagram of a system in which a customer may access a paperless services facility via a network such as a global network (e.g., the Internet) to engage in paperless transactions to manage, control or otherwise affect telecommunications services (communications services) such as local and long distance telecommunications services provided within a telecommunications network in accordance with a preferred embodiment of the present invention;

FIG. 2 is a diagram of a system in which telecommunications services may be provisioned and billed based on customer specifications received in real time and on-demand in connection with corresponding paperless transactions provided in accordance with a preferred embodiment of the present invention;

FIG. 3 is a block diagram of a data processing system that may be used to implement control systems, interfacing facilities, paperless services facilities, and database management facilities in accordance with a preferred embodiment of the present invention; and

FIG. 4 is a flowchart that illustrates exemplary operations that may be performed with system 100 (FIG. 1) to facilitate paperless transactions to manage, control or otherwise affect telecommunications services such as DSL based communications services provided within a telecommunications network in accordance with a preferred embodiment of the present invention.

### DETAILED DESCRIPTION OF THE PREFERRED EMBODIMENTS

The present invention is now discussed in detail with reference to the attached drawing figures which were briefly described above. Unless otherwise indicated, like parts and processes are referred to with like reference numerals.

### Structural Aspects of the Present Invention

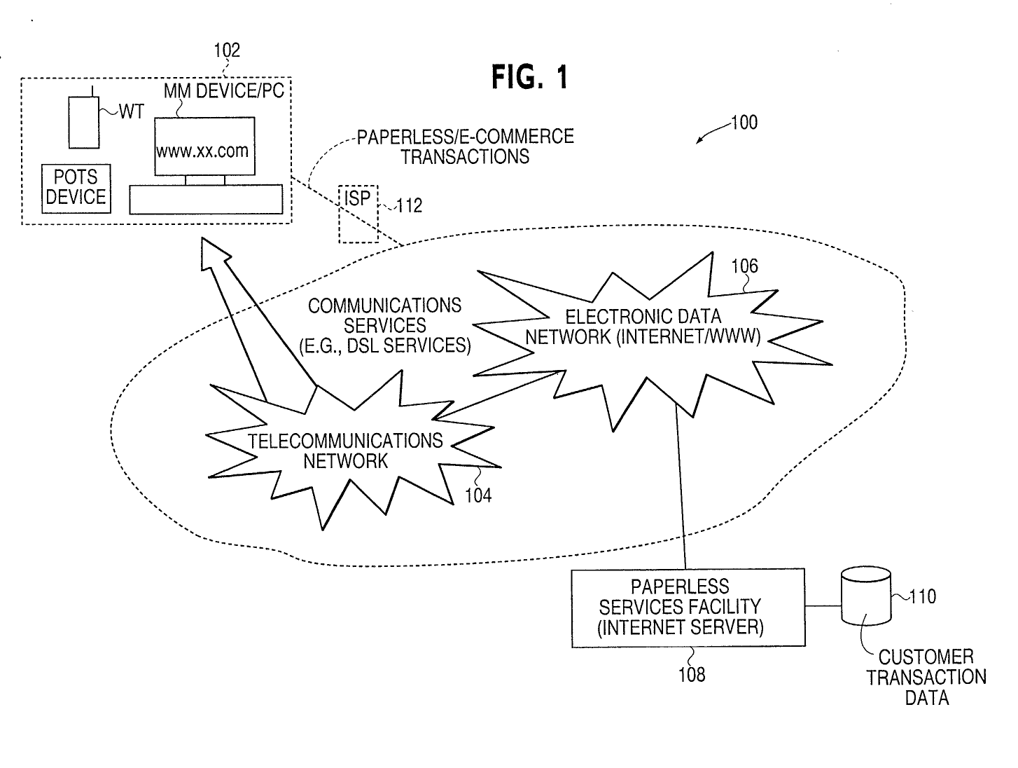

Referring now to FIG. 1, depicted therein is diagram of a system in which a customer may access a paperless services facility via a network such as a global network (e.g., the Internet) to engage in paperless transactions to manage, control or otherwise affect telecommunications services such as local and long distance telecommunication services provided within a telecommunications network in accordance with a preferred embodiment of the present invention.

In particular, system 100 includes communications devices 102 including wireless telephony devices, video data devices, plain old telephone service (POTS) devices and multimedia facilities allowing customers to receive communications services and to engage in paperless transactions related to such services in accordance to a preferred embodiment of the present invention. System 100 further includes a telecommunications network 104, which is coupled to an electronic data network such a global network (e.g., the Internet and world wide web (www)). Also included within system 100, is paperless services facility 108, database facility 110, and an Internet service provider or other telephony services provider 112.

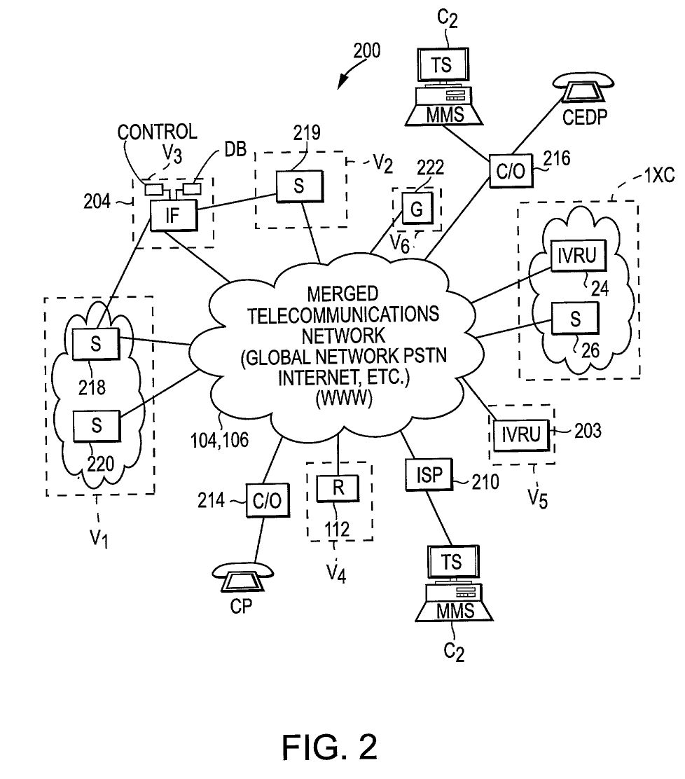

Paper services facility 108, in conjunction with database facility 110, provides a web enabled (e.g., web server based system) system that permits customers to engage in paperless transactions related to their communications services in real time. Accordingly, a customer may order and correspondingly provision DSL based services in the context of the present invention via a paperless transaction over the internet and then may access paperless services facility 108 to perform account management, make account payments, receive customer service information, etc. As will be described in greater detail below with regard to FIGS. 2 through 4, telecommunication services (communications services) may now be provisioned in real time based upon customer specifications and via paperless transactions enabled via online sessions such as those including web enabled forms and the like (e.g., HTML based forms). Such forms may be provided by paperless services facility 108 with may be configured as a web server facility, which will be readily understood by those skilled in the art.

In system 100, telecommunications network 104 and electronic data network 106 may be one in the same or may be a collection of networks. Accordingly, there is no requirement that telecommunications network 104 be the transport for paperless transactions in accordance with the present invention. Moreover, the telecommunications network 104 and electronic data network 106 are shown as being separate to identify different functionality that may be achieved via a networking system in accordance with the present invention.

In system 100, paperless transactions may be stored and processed via database facility 110 as will be readily understood by those skilled in the art after reviewing this patent document and the documents referenced herein.

Referring now to FIG. 2, depicted therein is a diagram of a system in which customers may access a merged telecommunication network to receive, control, manage, or otherwise affect communications services based on paperless transactions provided in accordance with a preferred embodiment of the present invention. Such communications services may include provisioned services from possibly a multitude of vendors, consolidated billing statements, etc. all in real time and via a web enabled interface such as one provided via paperless transaction facilities 108 (FIG. 1) that permits access via the Internet and World Wide Web (www). In particular, system 200 includes a merged telecommunications network which may include at least portions of a global network, the publicly switched telephone network (PSTN), the Internet and WWW, etc. The merged telecommunications network shown in FIG. 2 may combine telecommunications network 104 and such electronic data network 106 as shown and indicated by phantom lines containing networks 104 and 106 in FIG. 1. There is no requirement that any particular network be segmented away from any other network. To the contrary, the present invention contemplates the provisioning of communications services in any type of network including those that may utilize merged components for voice, data, video data, etc.

System 200 may include vendor communications systems V1 through V6 (among others), wherein each vendor system may include switching systems, interactive voice response units, control facilities and database management facilities, interfacing facilities and a host of other telecommunications devices found in modern telecommunications networks and which may be accessed in merged telecommunications network 104, 106 using a variety of modern communications protocols and device messaging schemes.

In system 200, a calling party such as calling party CP may utilize calling services through a central office 214 which is coupled to merged telecommunications network 104, 106 to receive communication services based upon communications functions provided by telecommunications devices such as those provided by vendors V1-V6. For example, a particular communications service may include the operations of a router such as router 112 in the context of data based services, voice response services, such as those provided by vendor V5 via IVRU unit 208, gateway services provided by gateway system 222 which is provided by vendor V6, etc. Moreover, communications services may include voice calls which ultimately terminate at a called party such as CEDP party via central office 216. Furthermore, customer systems C1 and C2 may incorporate multimedia telecommunications systems including computing platforms that facilitate multimedia communications via merged telecommunications network 104, 106. Such services may be provided via vendor systems V1 and V3 along with an InterExchange Carrier system denoted by system IXC (denoted by phantom lines forming a box around a vendor network that includes interactive voice response unit (IVRU) 224 and a switching platform 226).

Within system 200, vendor V3, for example, is shown to include control facilities, database management facilities DB and an interfacing facility IF. The control facilities in conjunction with the database management facilities DB and the interfacing facility IF, permit customers to custom configure (self-direct) telecommunications services on demand and in real time (e.g., during normal business operations) based on corresponding paperless transactions via couplings made automatically within merged telecommunications network 104, 106. For example, interfacing facility IF of vendor system V3 may incorporate switching facilities 218, 219, and 220 along with IVRU facilities 208 to provide a custom configured communications service (e.g., a DSL communications service) in real time. That is, each communications function provided by a particular telecommunications device or facility within system 200 may be treated as an inventory item within merged telecommunications network 104, 106, for example, to facilitate custom configuration and management of communications services such as local and long distance services on demand and based on customer requirements and specifications. Accordingly, a customer such as customer C2 may access merged communications network 104, 106 and ultimately, interfacing facility IF of vendor system V3 to custom configure bandwidth allocation services (such as for a special video conference, etc.) on demand and in real time without the need to request such services in advance and via live operator intervention. Accordingly, customer C2 may access an ISP system 210 to provide access to merged telecommunications network 104, 106, for example, to engage the operations of interfacing facility IF of vendor system V3 in the abstract so that in the event that communications functions provided by disparate telecommunications devices are needed to fulfill a particular customer request, it then can be provisioned in the abstract without requiring the customer to specifically understand or be able to message to possibly disparate telecommunications devices. Furthermore, a customer requiring merged voice and data type communications services now may access a merged telecommunication network in accordance with the present invention to ultimately access IXC services, such as voice response and switching services provided IVRU facilities 224 and switching facilities 226 in combination with other services provided within merged telecommunications network 104, 106 to provision or otherwise affect enhanced telecommunications services on demand and in real time based upon specific customer specifications.

Furthermore, the interfacing facilities provided by vendor V3, for example, permit telecommunications devices and facilities within merged telecommunications network 104, 106 to transmit billing and accounting data related to the provision of telecommunications services to a central or otherwise consolidated data facility such as data facility 204 which includes interfacing facility IF, control facilities and database management facilities, and to ultimately, provide such consolidated billing data to a customer for appropriate processing thereby. Such billing operations may now be carried out by the customer as paperless transactions without the need for periodic reports, customer service intervention, etc. For example, in the event that extended or extra bandwidth is a telecommunications service to be provided within merged telecommunications network 104, 106 at the request of a customer in real time, such extended bandwidth may require certain switching facilities, such as switching facility 218, and switching facility 219, to be included in the provision of that particular bandwidth telecommunications service. Accordingly, the present invention now permits switching system 218 and switching facility 219, for example, to transmit billing data to a consolidated billing facility whereby billing data, possibly incorporating billing data generated by disparate telecommunications devices (e.g., devices communicating and messaging in accordance with disparate telecommunications protocols, etc.), communicating in accordance with disparate protocols and messaging schemes, to be consolidated and ultimately reported within a single or consolidated notice or message provided via merged telecommunication network 104, 106 in the context of a paperless transaction such as one initiated via the Internet and manifested in an appropriate online document (e.g., HTML form, etc.).

The operations of interface facility IF within vendor system V3, for example, are illustrated and described in detail in co-owned, co-pending U.S. patent applications, Ser. Nos. 09/414,668 entitled “SYSTEM AND METHOD FOR COMMUNICATING WITH AND CONTROLLING DISPARATE TELECOMMUNICATIONS DEVICES IN A TELECOMMUNICATIONS NETWORK,” and 09/514,208 entitled the same as the '668 application, filed on Oct. 7, 1999, and Feb. 28, 2000, respectively, which are incorporated herein by reference. Accordingly, the reader of this patent document should refer to the aforementioned co-owned, co-pending U.S. patent application for complete disclosure details related to the operations of interfacing facility IF in the context of provisioning and providing provisioning operations based on common interfacing and messages along with consolidated billing operations in accordance with the present invention.

Furthermore, the operations to provision multiple device functions to deliver telecommunications services and to manage billing practices related to the same such as those which may be provisioned and billed (accounted for) in response to web based requests from customers, are detailed in co-owned, co-pending U.S. patent applications, Ser. Nos. 09/513,961 and 09/514,207 entitled “SYSTEM AND METHOD FOR PROVIDING COMMUNICATION SERVICES ON DEMAND BY PROVISIONING DEVICES IN CONVERGING TELECOMMUNICATIONS NETWORKS” and “SYSTEM AND METHOD FOR BILLING COMMUNICATIONS SERVICES PROVISIONED ON DEMAND IN CONVERGING TELECOMMUNICATIONS NETWORKS,” both filed on Feb. 28, 2000, which are hereby incorporated by reference. Accordingly, the reader of this patent document should refer to the aforementioned co-owned, co-pending U.S. patent applications for detailed disclosure related to this patent document.

The aforementioned and incorporated patent application documents and disclosures are hereby made part of this specification.

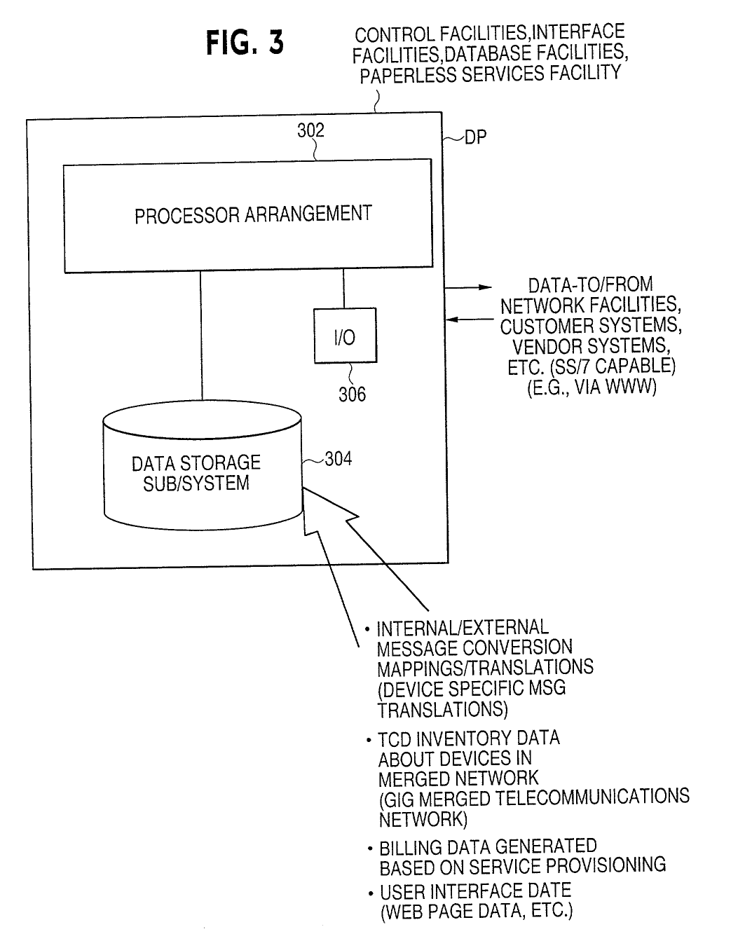

Referring now to FIG. 3, depicted therein is a block diagram of a computing system which may be used to implement control facilities, interfacing facilities, paperless services facilities, and database management facilities as described above with regard to FIGS. 1 and 2 in accordance with a preferred embodiment of the present invention. In particular, FIG. 3 depicts a data processing system DP which further includes a processor arrangement 302 including one or more processing elements, a data storage subsystem 304, and I/O facilities 306. The arrangement of these structures shown with data processing system DP will be immediately understood by those skilled in the art.

Data processing system DP is configured to receive and transmit data to and from network facilities, customer systems, vendor systems, etc. via modern telecommunications protocols including, but not limited to, those used in SS7 out-of-band signaling systems, TCP/IP protocols, H.323 communications protocols, and any other telecommunications protocols which may used to facilitate messaging between telecommunications devices in accordance with the present invention.

Data storage subsystem 304 as shown within data processing system DP, may include internal and external messaging conversion mappings and translations, which may be used to convert device specific messages (external messages) generated by specific telecommunications devices within merged telecommunications network 104, 106 (FIG. 2) into internal messages (IMs) which are device independent which may be used to consolidate application type data to including billing and operation data etc. Data storage subsystem 304 may store and provide telecommunications device (TCD) inventory data about particular telecommunication devices in merged telecommunications network 104, 106. And, data storage subsystem 304 may include billing data generated based on service provisioning and, in particular, billing data generated by particular telecommunications devices within merged telecommunications network 104, 106.

The structures described above with regard to FIGS. 1-3 are web enabled via open standards technology to support web based, paperless transactions and operations. The aforementioned and incorporated patent applications describe structure, processes, and methods which may be used to facilitate such web enabled functionality.

As such, the present invention permits all communication services to be e-services. That is, all services may now be bought, sold, managed and transacted over the Internet and other similar global type networks, etc. through a variety of protocols, transmission mediums, PDA's , wireless devices, backbone devices and vendors. Any company wishing to compete in this new world of communications must be prepared to operate over the Internet. Simply reducing the price on a paper invoice and mailing it won't satisfy customers embracing the Internet and demanding a world run in real-time.

Accordingly, service providers can now gain market share by offering personalized services. Self-provisioning and self-management gives customers the ability to customize their services. Providers can now distinguish themselves from competition by delivering a better user experience. Value is now defined more in terms of customer control, convenience and ease-of-use, rather than strictly on price.

The closed, single-vendor proprietary networks are not the future. Multi-vendor, multi-protocol open networks will dominate the new world of communications. To accomplish this, software systems are the core of network intelligence. Networks will need to support SS7, IN, IP, ATM, H.323, MGCP, Parlay, SIP and a host of protocols that have yet to be invented. Functionality must include multimedia call agents, protocol conversion, gatekeepers, applications, billing, costing, customer management, provisioning, e-commerce, fraud control, authentication, security and network management.

For next-generation systems to be viable the browser can be the only interface. The concept of location is where the Internet connection resides. Customers will demand that their Internet connection follows them rather than installed statically on a desktop PC. All systems must control, manage and deliver applications and content over the existing publicly switched telephone network “PSTN” infrastructure as well as all new world multimedia devices, protocols and languages as they are developed. Of course, everything must be integrated and seamless to the provider and the customer.

Every company that has tried it knows what a difficult task a multi-vendor integration effort is. Huge integration projects will cripple the companies attempting such a strategy in a market that moves in Internet-time. Opportunity cost alone is a reason to look for a more efficient model. The Internet model provides two key operational benefits—all network elements are managed from a single browser and back office, and customer care functions can be managed by the end-user on their own schedule.

By unifying the gamut of technologies available along with Internet-based front and back office applications and transaction-based billing, the present invention makes a new range of services and selling opportunities possible.

Existing proprietary technology and new technologies can for the first time, easily coexist which preserves existing investments, fully utilizes powerful existing technologies and leaves the door open for future technologies that become available.

The present invention supports carrier class TDM technologies by Nortel, Lucent, Ericsson, Siemens, Nokia, Alcatel and Cisco and a host of others. Through MGCP and H.323, the present invention supports all IP-based products. In the context of the present invention, SS7 is fully supported.

### Operational Aspects of the Present Invention

The structures described above with regard to FIGS. 1-3 have been configured to operate together in accordance with preferred embodiments of the present invention. Such embodiments are www enabled via open standards technology to support web based, paperless transactions and operations. Such paperless transactions may be used by communications services consumers and customers to control, provision, or otherwise affect or relate to such communications services. For example, a customer may now utilize the present invention to self-provision elaborate telecommunications services in real time and, possibly, by incorporating communications functions provided by a multitude of vendors via paperless transactions such as www transactions. As such, paperless transactions provided in accordance with the present invention may take the form of provisioning operations, billing operations, account management operations, customer service inquiries, etc.—any and all types of transactions that would otherwise require paper based solutions. The aforementioned and incorporated patent applications describe structure, processes, and methods which may be used to facilitate such functionality.

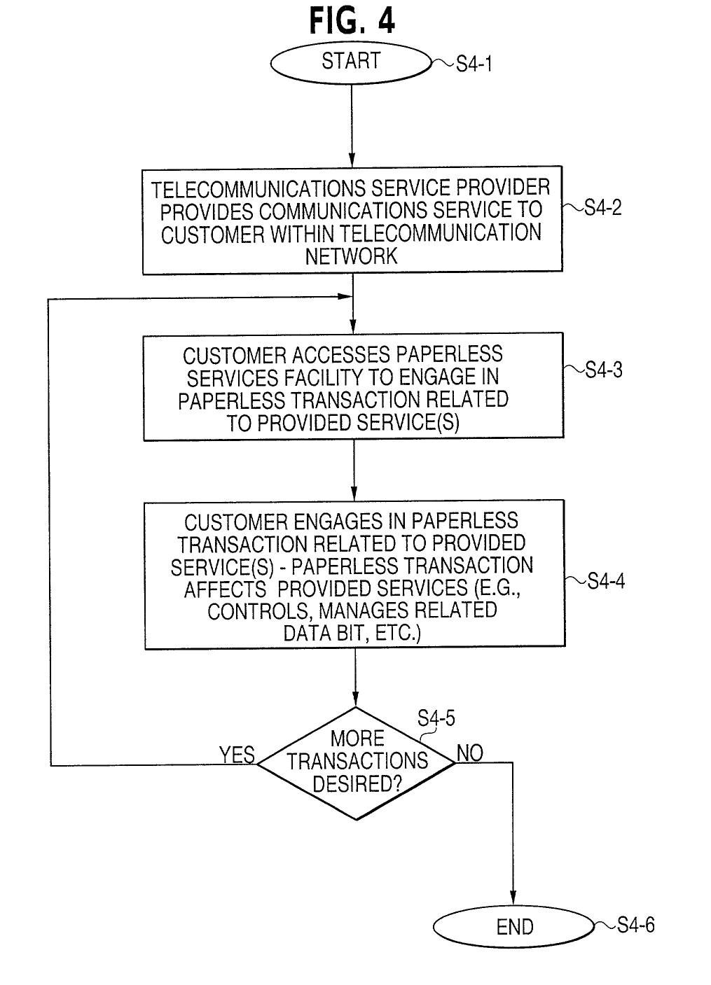

To further illustrate the operations carried out within system 100 to enable paperless transactions to facilitate acquisition and management of communications services, reference is now made to a flowchart shown in FIG. 4. In particular, processing and operations start at step S4-1 and immediately proceed to step S4-2.

At step S4-2, a telecommunications service provider such as a DSL or other similar or like service provider will provide (or be instructed to provide) telecommunications services to a customer within or via telecommunications network 104.

Next, at step S4-3, a customer will access paperless services facility 108 to engage in a paperless transaction related to services which are provided via telecommunications network 104. Such access may be achieved via a web connection achieved though an Internet Service Provider (ISP) or via any other well-known connection technique. Accordingly, access in the context of the present invention, includes web connectivity to allow a customer to engage in a forms based process carried out within a browser (e.g., a Web Browser such as MICROSOFT® INTERNET EXPLORER) which may be configured to run on the customer's data processing system and which may include a conventional personal computer, a wireless telephony device, a PDA, etc.

Next, at step S4-4, the customer will engage in the paperless transaction related to the services provided via telecommunications network 104. Such paperless transactions will affect services which are provided based upon customer specifications. Such an affect on the provided services may include control such as provisioning, management of telecommunications devices to provision services, or otherwise affect data related to the provided services such as that data which may be stored in database facilities shown and described with reference to FIG. 2.

Next, at step S4-5, a determination will be made as whether the customer desires to engage in additional transactions. If not, processing proceeds and ends at step S4-6.

If additional transactions are requested, the user may engage in additional web based paperless transactions whereby processing returns to step S4-3 as described above.

It is important to note that the processes and operations illustrated in FIG. 4 are merely exemplary and represent a typical process sequence whereby a customer may engage in paperless transactions to acquire and/or otherwise maintain and affect communications services which are provided via a telecommunications network.

In view of the foregoing discussion, it is worth noting that the present invention will permit paperless transactions to facilitate acquisition, provisioning, and generalized management related to wireless telephony services. Such paperless transactions operate to replace prior business practices and methods that often involve significant live operator intervention to facilitate actual service provisioning and customer account management. Accordingly, a customer may now specify a particular wireless communications service (e.g., periodic access/subscription services according to a plan, a customized billing arrangement plan for calls to particular locations, etc.) in real time and obtain and manage such services in real time without live operator intervention and/or without requiring paper based processes and systems. As such, consumers of wireless services now may access a web site, order services which are actually provisioned in real time, and return to that web site to self direct, change, and manage their services.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

What is claimed is:

1. A system for facilitating paperless transactions related to services provided within a telecommunications network, comprising:
a telecommunications network wherein at least one DSL type service is provided to a customer; and
a paperless services system coupled to said telecommunications network via an electronic data network, said paperless services system configured to be accessed by the customer via said electronic data network to enable the customer to engage in at least one paperless transaction related to said at least one DSL type communications service provided to the customer within said telecommunications network.

2. The system according to claim 1, wherein said paperless services system includes a server system configured to serve a user interface to the customer via said electronic data network, said user interface configured to permit the customer to engage in said at least one paperless transaction.

3. The system according to claim 2, wherein said server system is a web server and said electronic data network is the Internet, said user interface includes at least one form configured to permit user entry of data related said at least one paperless transaction.

4. The system according to claim 3, wherein said at least one form is an HTML form configured to be processed within a browser application running within a client data processing system coupled to said paperless services system via the Internet.

5. The system according to claim 1, wherein said paperless transaction is an electronic commerce transaction.

6. A method for facilitating paperless transactions related to communications services provided within a telecommunications network, comprising the steps of:
providing, within a telecommunications network, at least one wireless communications service to a customer; and
permitting the customer to access a paperless services system coupled to said telecommunications network via an electronic data network; and
permitting, via said electronic data network, the customer to engage in at least one paperless transaction related to said at least one wireless communications service provided to the customer within said telecommunications network.

7. The method according to claim 6, wherein said paperless services system includes a server system configured to serve a user interface to the customer via said electronic data network, said user interface configured to permit the customer to engage in said at least one paperless transaction.

8. The method according to claim 6, wherein said server system is a web server and said electronic data network is the Internet, said user interface includes at least one form configured to permit user entry of data related said at least one paperless transaction.

9. The method according to claim 6, wherein said at least one form is an HTML form configured to be processed within a browser application running within a client data processing system coupled to said paperless services system via the Internet.

10. The method according to claim 6, wherein said at least one wireless communications service is a voice based service.

11. The method according to claim 6, wherein said at least one paperless transaction is an order corresponding to the provisioning of said at least one communications service provided within said telecommunications network.

12. The method according to claim 6, wherein said at least one paperless transaction is an account management function corresponding to the customer and an account corresponding to the customer.

13. A system for facilitating paperless transactions via the Internet related to local and long distance communications services provided within a telecommunications network, comprising:
a telecommunications network wherein at least one local or long distance communications service is provided to a customer; and
a paperless services system coupled to said telecommunications network via the Internet, said paperless services system configured to be accessed by the customer via the Internet to enable the customer to engage in at least one paperless transaction related to said at least one local or long distance communications service provided to the customer within said telecommunications network.
